(19) United States
(12) Patent Application Publication
(10) Pub. No.: US 2006/0274478 A1
(43) Pub. Date: Dec. 7, 2006

(54) Etched capacitor laminate for reducing electrical noise

(75) Inventors: Macushla Chen, Kunshan City (TW); James Howard, Carson City, NV (US)

Correspondence Address: VIRTUAL LEGAL, P.C.;MICHAEL A. KERR, 3476 EXECUTIVE POINTE WAY, UNIT 16, CARSON CITY, NV, 89706, US

(73) Assignee: Wus Printed Circuit Co. Ltd., Kunshan City (CN)

(21) Appl. No.: 11/147,412

(22) Filed: Jun. 6, 2005

(51) Int. Cl. H01G 4/20; H01G 9/00

(52) U.S. Cl. 361/313; 361/306.1; 216/6; 216/13

(57) ABSTRACT

An etched capacitor laminate for reducing electrical noise. The etched capacitor laminate is configured to be an element of a printed circuit board. The etched capacitor laminate comprises a first conductive sheet, an intermediate sheet of dielectric material, and a second conductive sheet. The first conductive sheet further comprises a plurality of etched forms wherein each of the etched forms is causing a local capacitive effect and a local inductive effect. The local capacitive effect and local inductive effect generates a plurality of local filters that reduce electrical noise. The intermediate sheet of dielectric material is bonded to the first conductive sheet, and the second conductive sheet is also bonded to the intermediate sheet.

### BACKGROUND

1. Field of Invention

The invention is related to an etched capacitor laminate that reduces electrical noise. More particularly, the invention is related to an etched capacitor laminate that is an element of a printed circuit board.

2. Description of Related Art

Electrical noise is generated and radiated by printed circuit boards (PCBs) and integrated circuits (ICs). PCBs are laminated structures that accommodate a large number of electronic devices such as integrated circuits (ICs). Generally, these PCBs have internal power planes, ground planes, conductive sheets, traces and various other electrical devices. The electrical noise is caused by, inter alia, voltage fluctuations in the PCBs and the ICs.

Substantial efforts have been expended in the design of such PCBs and the devices arranged thereupon to compensate for voltage fluctuations arising between the power planes and ground planes in the PCBs. In particular, sensitive devices such as ICs mounted or formed on the board surface that are connected to both the power planes and ground planes are sensitive to voltage fluctuations.

One common solution to this problem has been the use of surface capacitors connected directly with the ICs. The surface capacitors are formed or mounted on the surface of the PCB and connected with the respective devices or integrated circuits. However, the use of surface capacitors substantially increases the complexity and cost of PCB manufacturing, and undesirably affects reliability.

Additionally, ICs and other such devices are a primary source of radiated energy that creates electrical noise. Different characteristics are commonly observed for ICs that operate at different speeds or frequencies. Accordingly, the PCBs and IC device arrays must be designed to assure necessary noise suppression at both high and low frequency operation.

A second solution to overcome the problem associated with electrical noise is to use a capacitor laminate. As is well known in the art, the capacitor laminate provides a bypass capacitive function for ICs mounted or formed on the PCB.

In each of these prior art solutions, little or no effort has been expended to reduce the electromagnetic interference (EMI) that is emitted from the edges of the PCB containing the capacitive plane devices. The edges of the internal capacitive planes are not terminated and the EMI on the power planes and the ground planes are not fully resolved by the capacitive plane. Thus, some of the electronic energy is radiated as noise from the edges of the printed circuit board. Therefore, it would be beneficial to reduce PCB edge radiation in a cost effective and simple manufacturing process. A reduction in PCB edge radiation has the overall effect of reducing electrical noise.

### SUMMARY

An etched capacitor laminate for reducing electrical noise. The etched capacitor laminate is configured to be an element of a printed circuit board (PCB). The etched capacitor laminate comprises a first conductive sheet, an intermediate sheet of dielectric material and a second conductive sheet. The intermediate sheet of dielectric material is bonded to the first and the second conductive sheet.

The first conductive sheet comprises a plurality of etched forms that are surrounded by a plurality of conductive elements. Each of the forms causes a local capacitive effect and each of the conductive elements causes a local inductive effect. As a result of the local capacitive effect and local inductive effect, filters are generated on the first conductive sheet. These filters reduce electrical noise.

In the illustrative example, the second conductive sheet also comprises a plurality of etched forms that are surrounded by conductive elements. The etched forms in the second conductive sheet are also configured to cause local capacitive effects and inductive effects that act like filters and reduce electrical noise.

By way of example and not of limitation, the etched forms comprise an array of first arcuate etches located on the first conductive sheet and an array of second arcuate etches located on the second conductive sheet. The first array of arcuate etches may be offset from the second array of arcuate etches. The first array of arcuate etches may be rotated approximately 90° relative to the second array of arcuate etches.

### BRIEF DESCRIPTION OF THE DRAWINGS

The following drawings provide one or more illustrative embodiments of the following description.

FIG. 1A is a perspective view of the layers of a printed circuit board (PCB) comprising an etched capacitor laminate.

FIG. 1B is a side view of the PCB in FIG. 1A.

FIG. 2A is an exploded perspective view of an illustrative etched form on a conductive sheet.

FIG. 2B shows an illustrative current (I) applied to the illustrative etched form of FIG. 2A.

FIG. 2C is an illustrative RLC circuit used to model local capacitive effects and local inductive effects associated with the illustrative etched form of FIG. 2A.

FIG. 2D is a top view of an illustrative etched form having semi-circular arcuate etches.

FIG. 2E is a top view of an illustrative etched form having elliptical arcuate etches.

FIG. 3A is a top view of an illustrative etched capacitor laminate that includes a first conductive sheet having a first etched form and a second conductive sheet (semitransparent) having a second etched form.

FIG. 3B is a schematic of the primary capacitor in the capacitor laminate of FIG. 3A.

FIG. 4 is another illustrative circuit used to model the local capacitive effects and local inductive effects associated with the illustrative etched capacitor laminate.

FIG. 5 is a chart showing the relative impedance values of different conductive sheets.

FIG. 6 is a flowchart of a method for manufacturing the etched capacitor laminate.

### DESCRIPTION

In the following detailed description, reference is made to the accompanying drawings, which form a part hereof, and which provide illustrative embodiments of the etched capacitor laminate and method for forming the etched capacitor laminate. These illustrative embodiments are described in sufficient detail to enable those skilled in the art to practice the invention, and it is to be understood that other embodiments may be utilized and that structural, logical and electrical changes may be made without departing from the spirit and scope of the claims. The following detailed description is, therefore, not to be taken in a limited sense.

The etched capacitor laminate described below reduces electrical noise in a printed circuit board (PCB) with a properly designed pattern of forms that are etched into one or more conductive sheets. Typically, PCB construction includes etching features in a capacitor laminate such as clearance holes or other similar features. Any noise filtering effects these etched features may have are accidental and produce a limited accidental filtering effect. A properly designed pattern of etch forms, as described in further detail, may be optimized to take full advantage of the filtering capacity that resides within the capacitor laminate to reduce electrical noise.

Electrical noise is caused by inter alia voltage fluctuations, electromagnetic interference (EMI) emitted from the edge of one or more PCBs, electronic noise form the power plane and/or ground plane, crosstalk, and other such undesirable electrical, magnetic, or electromagnetic signals that interfere with a desired signal. It shall be appreciated by those of ordinary skill in the art having the benefit of this disclosure that electrical noise is a general term that is used to characterize an interfering signal that affects or may affect the communications of a desired signal. The capacitor laminate described reduces the impact of the electrical noise on the desired signal.

For example, electrical noise may be caused by digital signals, which carry information by alternating between two voltages, i.e. a high voltage and a low voltage. A digital signal cannot transition instantaneously from the low voltage level to the high voltage level, or vice versa. The finite amount of time during which a digital signal transitions from the low voltage level to the high voltage level is called the rise time of the signal. Similarly, the finite amount of time during which a digital signal transitions from the high voltage level to the low voltage level is called the fall time of the signal. For the digital signals within such systems to remain stable for appreciable periods of time between transitions, the rise and fall times of the signals must decrease as signal frequencies increase. This decrease in signal transition times (i.e. rise and fall times) creates several problems within digital electronic systems, including signal degradation due to reflections, harmonic effects, and increased electromagnetic emissions.

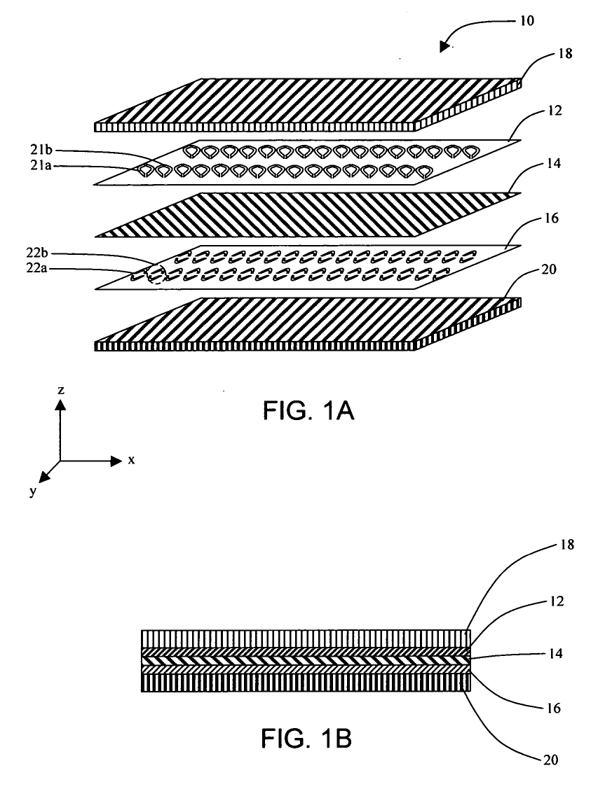

Referring to FIG. 1A, there is shown a perspective view of the multiple layers of a printed circuit board (PCB) comprising an etched capacitor laminate. The etched capacitor laminate is configured to be an element of a printed circuit board (PCB) 10. The etched capacitor laminate comprises a first conductive sheet 12, an intermediate sheet of dielectric material 14, and a second conductive sheet 16. The intermediate sheet of dielectric material 14 is bonded to the first conductive sheet 12 and the second conductive sheet 16. The dielectric layers 18 and 20 provide insulation for the first conductive sheet 12, and second conductive sheet 16, respectively. By way of example and not of limitation, the first conductive sheet 12 and second conductive sheet 16 may be associated with a power plane layer and ground plane layer, respectively, which is typically used in the construction of high speed digital PCBs.

The first conductive sheet 12 comprises a plurality of etched forms including etched forms 21a and 21b, which are surrounded by a plurality of conductive elements. By way of example and not of limitation, the etched forms are an array of first arcuate etches located on the first conductive sheet 12. Each of the etched forms causes a local capacitive effect and a local inductive effect. As a result of the local capacitive effect and local inductive effect, filters are generated on the first conductive sheet. These filters reduce electrical noise.

In the illustrative example, the second conductive sheet 16 also comprises a plurality of etched forms that are surrounded by conductive elements. By way of example and not of limitation, the etched forms comprise an array of second arcuate etches located on the second conductive sheet 16. The etched forms include the arcuate etches 22a and 22b, which are near the arcuate etches 21a and 21b. The first array of arcuate etches are offset from the second array of arcuate by a particular distance along the x-axis and/or y-axis. Additionally, the first array of arcuate etches are rotated approximately 90° relative to the second array of arcuate etches. The second array of arcuate etches in the second conductive sheet 16 are also configured to cause a local capacitive effect and a local inductive effect, which acts like another filter to reduce electrical noise.

Referring to FIG. 1B, there is shown a side view of the PCB in FIG. 1A, in which the capacitor laminate comprises the first conductive sheet 12, intermediate sheet of dielectric material 14, and the second conductive sheet 16, which are sandwiched between dielectric layers 18 and 20. In a more broad embodiment, the layer thickness of the first conductive sheet 12 and second conductive sheet 16 has a thickness of less than 0.002″ (50 μm). In a less broad embodiment, the layer thickness of the first conductive sheet 12 and second conductive sheet 16 has a thickness that is less than 0.0001″ (2.5 μm). It shall be appreciated by those of ordinary skill in the art that the actual thickness of the conductive sheets will depend with the type of electrical noise, the magnitude of the electrical noise, the type of conductor, the type of dielectric and the particular application and environment that the PCB is exposed to.

The intermediate dielectric sheet 14 may be formed by coating, electroplating, electrostatically depositing, vapor depositing or laminating the dielectric material to the first conductive sheet 12 and subsequently attaching the second conductive sheet 16 to the opposite side of the intermediate dielectric sheet 14. In yet another embodiment, multiple dielectric sheets may sandwiched between the conductive sheets. It shall be appreciated by those of ordinary skill in the art having the benefit of this disclosure that the dielectric material layer 14 will vary as to thickness depending on the particular application.

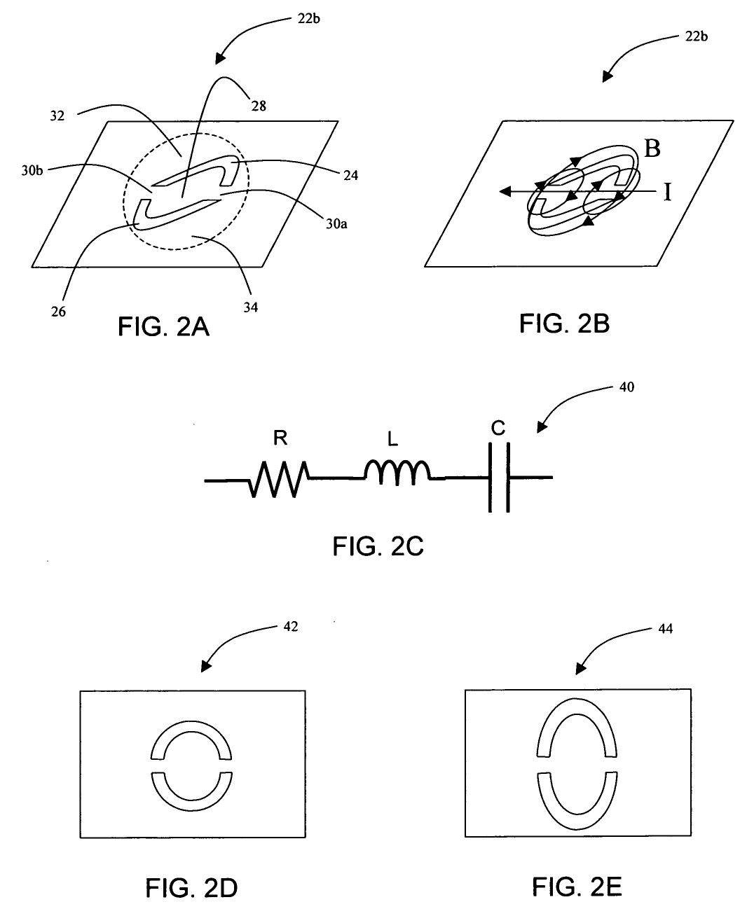

Referring to FIG. 2A, there is shown an exploded perspective view of an illustrative etched form 22b. The illustrative etched form 22b comprise a first arcuate etch 24 and a second arcuate etch 26. Each of the arcuate etches is in the shape of an arc or curve. The dimensions of the arcuate etch are dependent of the type and magnitude of electrical noise that is reduced. The first arcuate etch 24 and second arcuate etch 26 are surrounded by a first center round conductive element 28, a second pair of conductive elements 30a and 30b that provide inductive paths, and by a third and fourth conductive element 32 and 34 that are on the outside perimeter of the arcuate etches 24 and 26, respectively.

Referring to FIG. 2B, there is shown an illustrative current (I) applied to the illustrative etched form 22b. By way of example and not of limitation, the illustrative conductive elements 28, 30a, and 30b carry a current (I), which creates a magnetic field (B) around the wire in concentric circles. The number of magnetic field lines that pass perpendicular through an area is referred to as the magnetic flux. According to Faraday's law, if the magnetic flux in a circuit changes for any reason then an electric field is generated in the circuit, which is referred to as induced electromotive force. Inductance is a property of an electric circuit by which an electromotive force is induced in it by a variation of current either in the circuit itself or in a neighboring circuit. Inductance is equal to the ratio of the induced electromotive force to the rate of change of the inducing current. Thus, by applying a changing current to conductive elements 28, 30a, and 30b, a local inductive effect is generated.

Additionally, the arcuate etches 24 and 26 that are etched into the conductive sheet are filled with a dielectric material. Since the dielectric filled arcuate etches 24 and 26 are surrounded by conductive elements 28, 30a, 30b, 32 and 34, each of the arcuate etches is configured to perform as a capacitor. Thus, by applying a changing current to the illustrative etched forms, e.g. arcuate etches 24 and 26, a local capacitive effect is generated.

Referring to FIG. 2C, there is shown an illustrative RLC circuit used to model local capacitive effects and local inductive effects associated with the illustrative etched form 22b. For illustrative purposes only, the RLC circuit 40 may be used to model the local inductive effects and local capacitive effects associated with illustrative etched form 22b disposed on the second conductive sheet 16. The illustrative RLC circuit 40 acts as a filter that reduces electrical noise. By way of example and not of limitation, the illustrative RLC circuit 40 acts like a local filter that is configured to dampen voltage fluctuations.

The illustrative arcuate etches 21a, 21b, 22a, and 22b can also take a variety of other forms. For example in FIG. 2D, there is shown a top view of an illustrative etched form having semi-circular arcuate etches 42. Another illustrative example is provided in FIG. 2E, where a top view of an illustrative etched form having elliptical arcuate etches 44 is shown.

There are various shapes and sizes that the etched forms may take to enhance noise suppression. Other etch form shapes include, but are not limited to, symmetrical planar shapes such as squares, rectangles, diamonds, circles, ovals, pentagons, hexagons, and other such symmetrical shapes. The etch form shape may also be non-symmetrical planar shapes. Furthermore, the etch form shape may be a combination of a symmetrical planar shape and a non-symmetrical planar shapes. Therefore, it shall be appreciated by those of ordinary skill in the art having the benefit of this disclosure, that a variety of different shapes may suggest themselves which provide a local capacitive effect and local inductive effect that can be used to form a filter that reduces electrical noise and dampens voltage fluctuations and/or reduces EMI radiation emanating from the edges of the PCB.

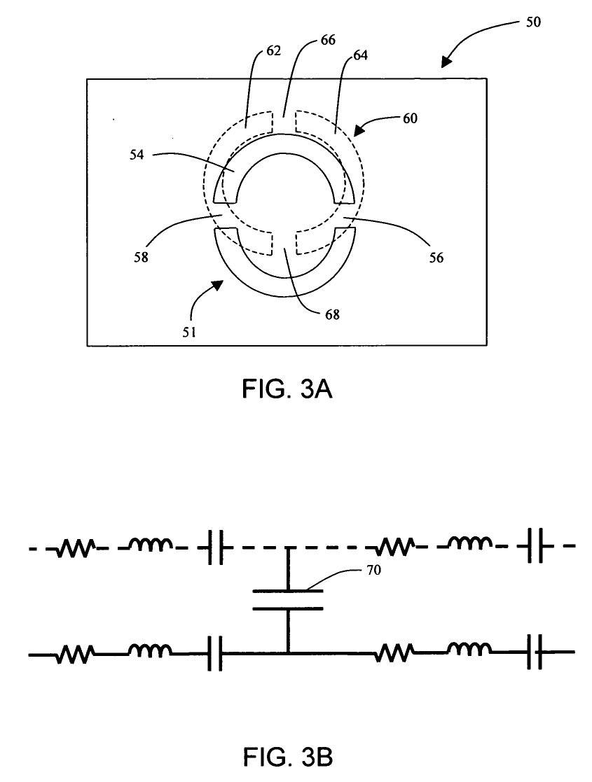

Referring to FIG. 3A, there is shown a top view of an illustrative etched capacitor laminate 50 that includes a first conductive sheet having a first etched form 51 and a second conductive sheet (semitransparent) having a second etched form 60. The first etched form 51 comprises two arcuate etches 52 and 54 that have two conducting elements 56 and 58, which provide inductive paths. The second etched form 60 also comprises two arcuate etches 62 and 64 that have two associated inductive paths defined by conducting elements 66 and 68. The conducting elements 56, 58, 66, and 68 may be aligned in any relative orientation to achieve the desired local capacitive effect and local inductive effect. The illustrative orientation provided in FIG. 3A is only provided as an illustrative example.

Referring to FIG. 3B, there is shown a schematic of the primary capacitor in the capacitor laminate 50. The primary capacitance 70 is related to the intermediate dielectric layer sandwiched between the first conductive sheet and the second conductive sheet. The value of the primary capacitance is based on the formula:
C=AεD/t
where,
C is capacitance in picofarads,
A is area in inches,
ε is the dielectric constant of the dielectric material between the conductive sheets,
D is a constant of 225, and
t is the thickness of the dielectric in mil.

The formula above illustrates that a change in dielectric constant or dielectric thickness can also change the primary capacitance 70. In one broad illustrative embodiment, the dielectric thickness is less than 2 mils and the dielectric constant is greater than 4.0.

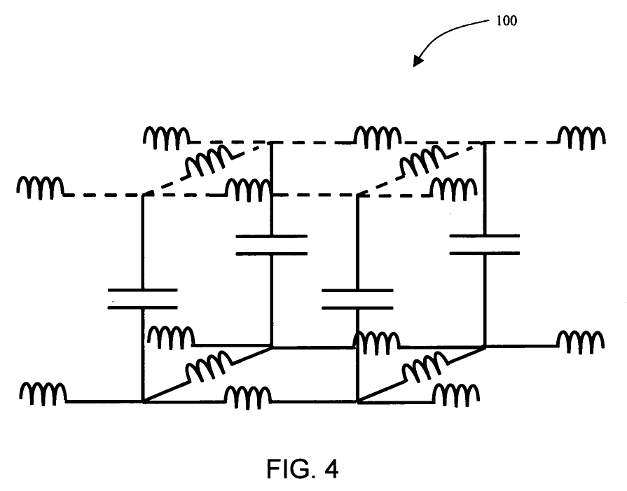

Referring to FIG. 4, there is shown another illustrative circuit used to model the local capacitive effects and local inductive effects associated with the illustrative etched capacitor laminate. The illustrative circuit 100 provides another model of the local capacitive effects and local inductive effects. The resulting filter network reduces electrical noise by reducing EMI radiated from the edges of a PCB. For example, high frequency electrical noise may be shunted through the capacitive interface, which is identified by the vertical capacitors; while the inductive paths would appear resistive to the same high frequency electrical noise. This effect provides a reduction in electrical noise that is transmitted toward the edges of the PCB. The schematic also shows the spatial quality of the local inductive effects and local capacitive effects, wherein the local inductive effects and the local capacitive effects may differ from one location to another. Therefore, the noise filtering effect may also change as a function of location.

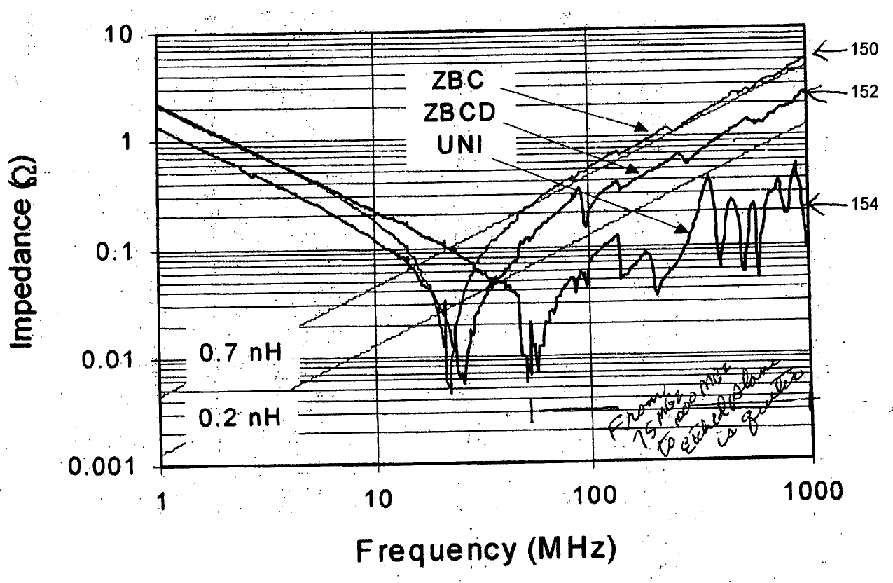

Referring to FIG. 5, there is shown a chart with the relative impedance values of different conductive sheets that act like an illustrative power plane and an illustrative ground plane for an illustrative printed circuit board. The first trace 150 represents a single conductive sheet composed of copper that has does not have etched forms. The second trace 152 represents two conductive sheets composed of copper that also do not have etched forms. The third trace 154 has had forms (i.e. holes) etched into two copper conductive sheets. Although, the etched form in the third trace 154 are not arcuate etches, the third trace 154 shows that from 75 MHz to 1000 MHz, the etched conductive sheets have a lower impedance than the conductive sheets that were not etched. As a result, the etched conductive sheets represented by third trace 154 were “quieter” than the other conductive sheet, and were able to reduce electrical noise. The reduced electrical noise includes, but is not limited to, reducing EMI radiating from the edges of the PCB.

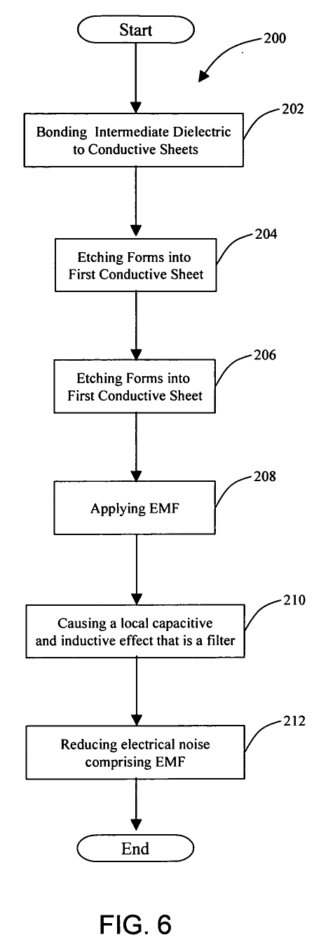

Referring to FIG. 6 and FIG. 1, there is shown a flowchart 200 of an illustrative method for manufacturing the etched capacitor laminate to reduce electrical noise in a PCB. The method is initiated at block 202 with the bonding of an intermediate dielectric sheet 14 between a first conductive sheet 12 and a second conductive sheet 16. The method then proceeds to block 204 where a first plurality of etched forms are etched into the first conductive sheet 12. As described in the illustrative example above, the etched forms may comprise arcuate etches. At block 206, a second plurality of etched forms are etched into the second conductive sheet 16. The capacitor laminate is then sandwiched between two dielectric layers as described above.

At block 208, an electromotive force (EMF) is then applied to the capacitor laminate. The applied EMF causes a local capacitive effect and local inductive effect which may be associated with each etched form. For practical purposes, current instrumentation makes it difficult to measure the inductive and capacitive effects associated with each etched form. However, measurable data may be gathered for a grouping of etched forms. The result of this grouping of etched forms is that they act as a noise filter, that reduces electrical noise, as shown in block 212. The electrical noise includes, but is not limited to, EMI radiating from the edges of a PCB.

The filtering capacity of the capacitor laminate described above may be modified structurally and electrically depending on particular design requirements. Although the description above contains many limitations in the specification, these should not be construed as limiting the scope of the claims but as merely providing illustrations of some of the embodiments of this invention. Many other embodiments will be apparent to those of skill in the art upon reviewing the description. Thus, the scope of the invention should be determined by the appended claims, along with the full scope of equivalents to which such claims are entitled.

What is claimed is:

1. An etched capacitor laminate for reducing electrical noise in a printed circuit board, said etched capacitor laminate comprising:
a first conductive sheet that comprises
a first plurality of etched forms that are etched into said first conductive sheet, each said first plurality of etched forms causing a local capacitive effect and a local inductive effect;
a first plurality of local filters comprising said local capacitive effect and said local inductive effect;
an intermediate sheet of dielectric material bonded to said first conductive sheet; and
a second conductive sheet bonded to said intermediate sheet.

2. The etched capacitor laminate of claim 1 wherein said first plurality of local filters is configured to dampen voltage fluctuations.

3. The etched capacitor laminate of claim 1 wherein said second conductive sheet comprises
a second plurality of etched forms that are etched into said second conductive sheet, each said second plurality of etched forms causing a local capacitive effect and a local inductive effect;
a second plurality of local filters comprising said local capacitive effect and said local inductive effect;

4. The etched capacitor laminate of claim 1 wherein said second plurality of local filters is configured to dampen voltage fluctuations.

5. The etched capacitor laminate of claim 1 wherein said first plurality of etched forms on said first conductive sheet comprises a first array of arcuate etches.

6. The etched capacitor laminate of claim 3 wherein said first plurality of etched forms on said first conductive sheet comprises a first array of arcuate etches and said second plurality of etched forms on said second conductive sheet comprises a second array of arcuate etches.

7. The etched capacitor laminate of claim 6 wherein said first array of arcuate etches are offset from said second array of arcuate etches.

8. The etched capacitor laminate of claim 6 wherein said first array of arcuate etches is rotated approximately 90° relative to said second array of arcuate etches.

9. A laminate for reducing electrical noise in a printed circuit board, comprising:
a first conductive sheet having a first plurality of etched forms that are surrounded by a plurality of conductive elements,
each of said first plurality of forms causing a local capacitive effect,
each of said first plurality of conductive elements causing a local inductive effect,
a first plurality of local filters disposed on said first conductive sheet, each of said local filters comprising said local capacitive effect and said local inductive effect;
an intermediate sheet of dielectric material bonded to said first conductive sheet; and
a second conductive sheet bonded to said intermediate sheet.

10. The laminate of claim 9 wherein said first plurality of local filters is configured to dampen voltage fluctuations.

11. The laminate of claim 9 wherein said second conductive sheet having a second plurality of etched forms that are surrounded by a plurality of conductive elements,
each of said second plurality of forms causing a local capacitive effect,
each of said second plurality of conductive elements causing a local inductive effect,
a second plurality of local filters disposed on said said conductive sheet, each of said local filters comprising said local capacitive effect and said local inductive effect;

12. The laminate of claim 11 wherein said second plurality of local filters is configured to dampen voltage fluctuations.

13. The laminate of claim 9 wherein said first plurality of etched forms on said first conductive sheet comprises a first array of arcuate etches.

14. The laminate of claim 11 wherein said first plurality of etched forms on said first conductive sheet comprises a first array of arcuate etches, and said second plurality of etched forms on said second conductive sheet comprises a second array of arcuate etches.

15. The laminate of claim 14 wherein said first array of arcuate etches are offset from said second array of arcuate etches.

16. The laminate of claim 14 wherein said first array of arcuate etches is rotated approximately 90° relative to said second array of arcute etches.

17. A method of manufacturing an etched capacitor laminate configured to reduce electrical noise in a printed circuit board, comprising:
bonding an intermediate dielectric sheet between a first conductive sheet and a second conductive sheet;
etching a first plurality of etched forms into said first conductive sheet;
etching a second plurality of etched forms into said second conductive sheet;
causing said first plurality of etched forms and said second plurality of etched forms to cause a local capacitive effect and a local inductive effect; and
causing said etched capacitor laminate to generate a plurality of local filters comprising said local capacitive effect and said local inductive effect, said plurality of local filters configured to reduce electrical noise.

18. The method of claim 17 wherein said first plurality of etched forms comprises a first array of arcuate etches.

19. The method of claim 17 wherein said first plurality of etched forms comprises a first array of arcuate etches and said second plurality of etched forms comprises a second array of arcuate etches.

20. The method of claim 19 wherein said first array of arcuate etches is offset from said second array of arcuate etches.
